(19) United States
(12) Patent Application Publication
(10) Pub. No.: US 2023/0158723 A1
(43) Pub. Date: May 25, 2023

(54) INJECTION MOLDING SYSTEM

(71) Applicant: FANUC CORPORATION, Minamitsuru-gun (JP)

(72) Inventor: Nobuatsu TSUCHIYA, Minamitsuru-gun, Yamanashi-ken (JP)

(21) Appl. No.: 17/917,442

(22) PCT Filed: Apr. 8, 2021
(86) PCT No.: PCT/JP2021/014869

§ 371 Date: Oct. 6, 2022

(30) Foreign Application Priority Data
Apr. 10, 2020 (JP) 2020-070698

(51) Int. Cl. B29C 45/42; B29C 45/76

(52) U.S. Cl. CPC B29C 45/42; B29C 45/7626; B29C 2045/4291; B29C 2045/7633

(57) ABSTRACT

An injection molding system that is advantageous for installation at a location having limited space and improves workability of a mold by an operator, includes an injection molding machine including a mold clamping device that opens and closes the mold and a machine stand that supports the mold clamping device from below; a work device that is provided below the mold clamping device and implements an operation for extracting a molded article from the mold and/or an operation for inserting an insert article into the mold; and, below the mold clamping device, a guide rail for evacuating the work device from below the mold.

An injection molding system that is advantageous for installation at a location having limited space and improves workability of a mold by an operator, includes an injection molding machine including a mold clamping device that opens and closes the mold and a machine stand that supports the mold clamping device from below; a work device that is provided below the mold clamping device and implements an operation for extracting a molded article from the mold and/or an operation for inserting an insert article into the mold; and, below the mold clamping device, a guide rail for evacuating the work device from below the mold.

### TECHNICAL FIELD

The present invention relates to an injection molding system.

### BACKGROUND ART

There has been proposed an injection molding system including an injection molding machine having a mold clamping device that opens and closes a mold, and a working device that performs a task of taking out a molded product from the mold. JP H06-155519 A discloses an example thereof.

### SUMMARY OF THE INVENTION

JP H06-155519 A discloses a configuration in which a robot for performing a taking-out task is installed on a side of an injection molding machine. This configuration is difficult to realize in a case where an installation space for the robot cannot be secured on a side of the injection molding machine.

Further, the robot disclosed in JP H06-155519 A is installed on an installation pedestal on the side of the mold. In this configuration, the installation pedestal and the robot hinder an operator from performing tasks or operations around the mold. This is not preferable from the viewpoint of workability of the operator.

An object of the present invention is to provide an injection molding system which is advantageous for installation in a place where space is limited, and which improves the workability of an operator with respect to a mold.

An aspect of the present invention is an injection molding system including: an injection molding machine including a mold clamping device configured to open and close a mold and a machine base configured to support the mold clamping device from below; a working device that is provided under the mold clamping device and is configured to perform at least one of a task of taking out a molded product from the mold or a task of inserting an insert into the mold; and a guide rail configured to retreat the working device from under the mold, in a location under the mold clamping device.

According to the present invention, an injection molding system is provided which is advantageous for installation in a place where space is limited, and which improves workability of an operator with respect to a mold.

### BRIEF DESCRIPTION OF DRAWINGS

FIG. 1 is a configuration diagram of an injection molding system according to an embodiment of the present invention;

FIG. 2 is a schematic configuration diagram of a control device according to the embodiment;

FIG. 3 is a view for explaining a working position;

FIG. 4 is a diagram for explaining a retreated position;

FIG. 5 is a flow chart illustrating the flow of a method of controlling the injection molding system of the embodiment;

FIG. 6 is a configuration diagram of an injection molding system according to a first modification;

FIG. 7 is a configuration diagram of an injection molding system according to a second modification;

FIG. 8 is a view for explaining a first position (lower position) in a case where a working device performs a task of taking out a molded product from a mold;

FIG. 9 is a view for explaining a second position in a case where the working device performs a task of placing the molded product taken out from the mold at a predetermined position;

FIG. 10 is a configuration diagram of an injection molding system according to a tenth modification;

FIG. 11 is a first view for explaining an injection molding system according to an eleventh modification;

FIG. 12 is a second view for explaining the injection molding system of the eleventh modification;

FIG. 13 is a configuration diagram of an injection molding system according to a twelfth modification;

FIG. 14 is a first view of the injection molding system of FIG. 13 viewed from an opening direction side of the injection molding machine;

FIG. 15 is a second view of the injection molding system of FIG. 13 viewed from the opening direction side of the injection molding machine;

FIG. 16 is a configuration diagram of an injection molding system according to a thirteenth modification; and

FIG. 17 is a schematic configuration diagram of a centralized control apparatus.

### DESCRIPTION OF THE INVENTION

An injection molding system according to the present invention will be detailed below by describing a preferred embodiment with reference to the accompanying drawings.

### Embodiments

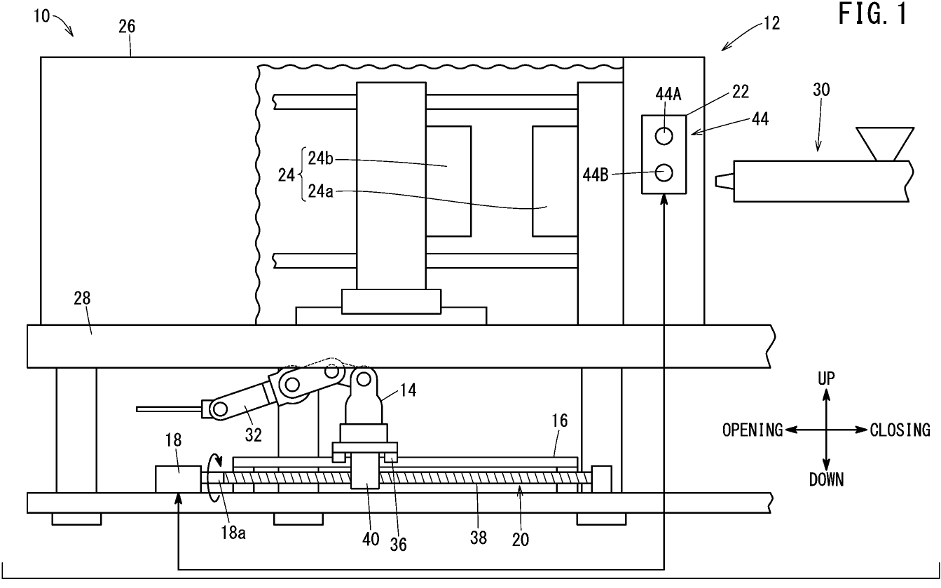

FIG. 1 is a configuration diagram of an injection molding system 10 according to an embodiment of the present invention.

The injection molding system 10 includes an injection molding machine 12, a working device 14, a guide rail 16, a servo motor (actuator) 18, a ball screw mechanism 20, and a control device 22.

The injection molding machine 12 includes a mold clamping device 26 that opens and closes a mold 24 and a machine base 28 that supports the mold clamping device 26 from below. The injection molding machine 12 further includes an injection device 30 that plasticizes a molding material and injects the molding material into the mold 24.

The mold 24 opens and closes in directions in which the mold clamping device 26 and the injection device 30 face each other. That is, the mold 24 has a fixed mold 24a and a movable mold 24b that comes into contact with and separates from the fixed mold 24a. The mold 24 is opened when the fixed mold 24a and the movable mold 24b are separated from each other, and is closed when the fixed mold 24a and the movable mold 24b are brought into contact with each other. The movable mold 24b is moved by driving of the mold clamping device 26.

The opening direction shown in FIG. 1 is a moving direction of the movable mold 24b when moving away from the fixed mold 24a. Further, the closing direction is a moving direction of the movable mold 24b when approaching the fixed mold 24a. Hereinafter, the closing direction and the opening direction are also collectively referred to as an opening/closing direction. The opening/closing direction is orthogonal to the direction of gravity (up-down direction in FIG. 1).

The working device 14 is a device that performs a task of taking out a molded product from the mold 24 (hereinafter, simply referred to as “taking-out task”). The working device 14 of the present embodiment is a robot having an articulated arm 32 capable of gripping a molded product when performing the taking-out task, that is, an arm robot. However, the working device 14 is not limited to the arm robot, and may perform the taking-out task by using a driving mechanism other than the articulated arm 32.

In the present embodiment, the working device 14 is provided under the mold clamping device 26 (i.e., in a dead space of the machine base 28). In this configuration, since the working device 14 is accommodated within the machine base 28, when installing one injection molding machine 12 and one working device 14, it is enough to just secure a space for the one injection molding machine 12. Therefore, the injection molding system 10 of the present embodiment is advantageous for installation in a place where space is limited, compared to a configuration in which the working device 14 is provided on the side (or above) of the injection molding machine 12.

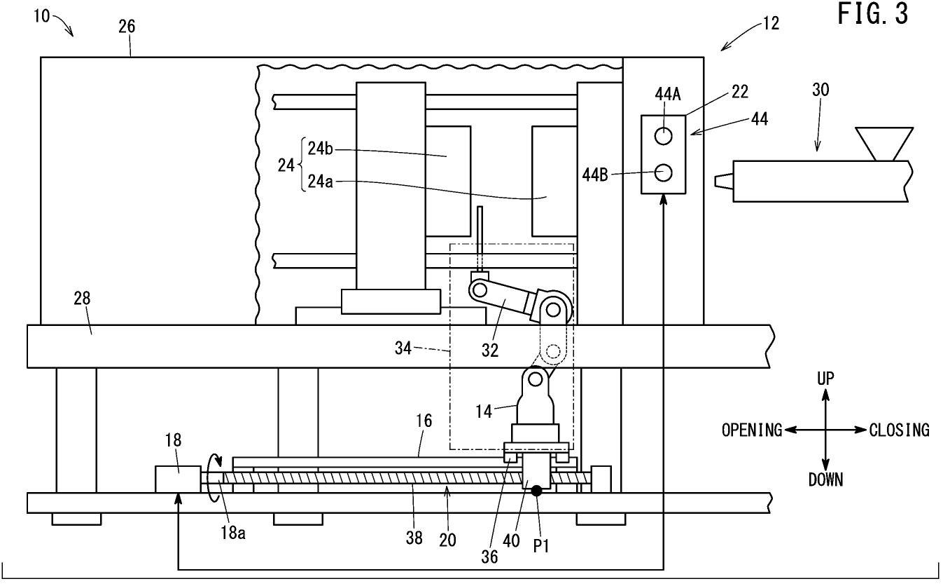

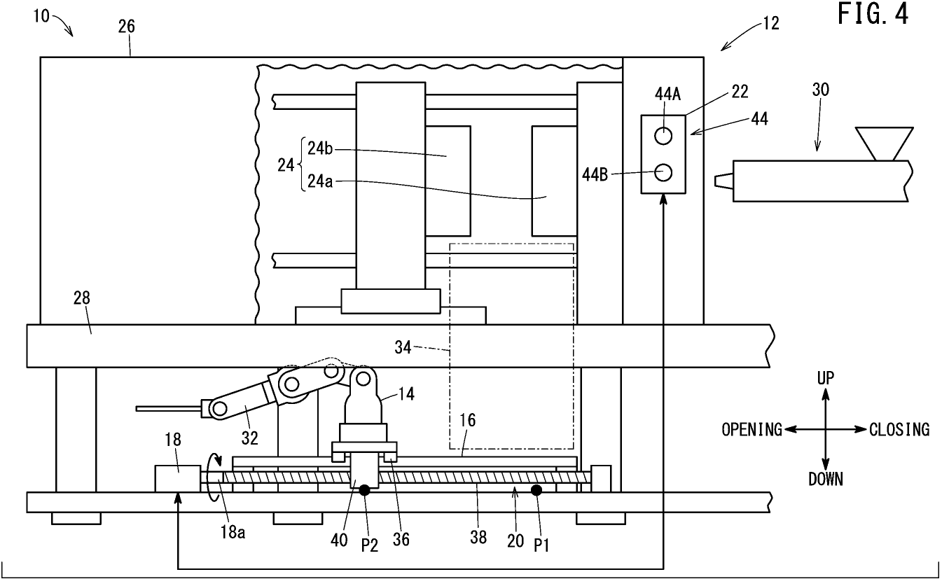

The guide rail 16 is installed under the mold clamping device 26 in order to retract or retreat the working device 14 from under the mold 24. The guide rail 16 of the present embodiment extends at least between a working position (lower position) P1 and a retracted position or retreated position P2, which will be described later, in parallel to the opening/closing direction of the mold 24 (FIGS. 3 and 4).

In the present embodiment, the working device 14 is provided with a slider (guide block) 36 configured to be slidably fitted to the guide rail 16. Thus, the working device 14 is supported by the guide rail 16 so as to be movable parallel to the opening/closing direction.

The servo motor 18 generates a driving force for moving the working device 14 along the guide rail 16. Since the servo motor 18 generates the driving force, the working device 14 can be moved without being manually pushed by an operator.

The servo motor 18 includes a rotary shaft 18a. The servo motor 18 generates a rotational force by rotation of the rotary shaft 18a.

The ball screw mechanism 20 includes a ball screw 38 and a nut 40. The ball screw 38 is a screw shaft installed in parallel to the guide rail 16. The rotary shaft 18a of the servo motor 18 is connected to the ball screw 38 so as to be integrally rotatable. The nut 40 is a member that is screw-engaged with the ball screw 38, and is provided in the working device 14.

Thus, the rotational force of the servo motor 18 is converted into a driving force parallel to the guide rail 16. Further, the driving force is transmitted to the working device 14. As a result, in the present embodiment, it is possible to move the working device 14 in the opening/closing direction, which is parallel to the guide rail 16. The movement of the working device 14 in the opening direction and the movement thereof in the closing direction can be easily switched by changing the rotation direction of the rotary shaft 18a.

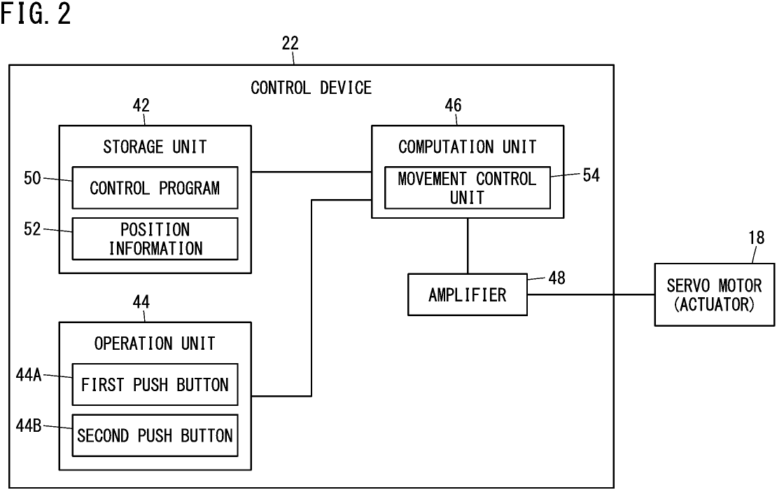

FIG. 2 is a schematic configuration diagram of the control device 22 according to the embodiment.

The control device 22 is a device that controls movement of the working device 14 along the guide rail 16 by controlling at least the servo motor 18 described above. The control device 22 is equipped with a storage unit 42, an operation unit 44, a computation unit 46, and an amplifier 48.

The storage unit 42 stores information and is configured by hardware such as a RAM (random access memory) and a ROM (read only memory). The storage unit 42 stores a predetermined control program 50.

The control program 50 is a program that can be read and executed by the computation unit 46. The control program 50 specifies information necessary for controlling the servo motor 18.

In addition, the storage unit 42 stores information (position information 52) indicating a working position P1 and a retreated position P2 which are predetermined as positions of the working device 14.

FIG. 3 is a diagram for explaining the working position P1.

The working position P1 is a position that is under the mold 24, and is a predetermined position at which the working device 14 performs the taking-out task. The working device 14 that is at the working position P1 performs tasks in a working space 34 around the mold 24. The storage unit 42 may store a plurality of different working positions P1 according to the type of the mold 24 and the type of the molded product.

FIG. 4 is a diagram for explaining the retreated position P2.

The retreated position P2 is a predetermined position that avoids or stays away from the working space 34. The working device 14 that is at the retreated position P2 stands by on the spot without performing the taking-out task.

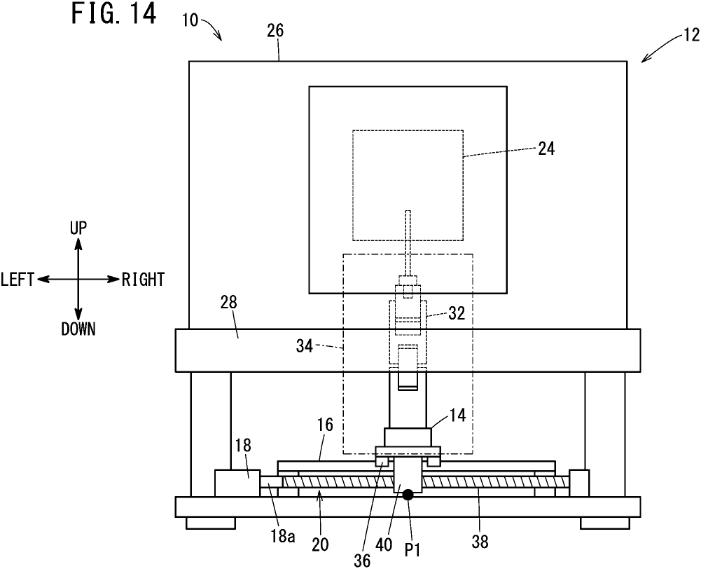

As shown in FIG. 4, the retreated position P2 of the present embodiment is under the mold clamping device 26 supported by the machine base 28, and is closer to the opening direction side than the above-described working position P1. This reduces the possibility that the working device 14 moved to the retreated position P2 protrudes outside the machine base 28 in the widthwise direction of the machine base 28 (see the left-right direction in FIG. 14) orthogonal to the up-down direction and the opening/closing direction.

The operation unit 44 is an interface operated by the operator when the operator wants to move the working device 14. The operation unit 44 of the present embodiment includes a first push button 44A that is pushed when the working device 14 is to be moved to the retreated position P2, and a second push button 44B that is pushed when the working device 14 is to be moved to the working position P1. In this case, the operation performed on the operation unit 44 by the operator is that the operator presses the first push button 44A or the second push button 44B.

When the first push button 44A is pushed, the operation unit 44 outputs a signal for moving the working device 14 to the retreated position P2 to the computation unit 46, and when the second push button 44B is pushed, the operation unit 44 outputs a signal for moving the working device 14 to the working position P1 to the computation unit 46.

The computation unit 46 performs arithmetic processing on information, and is configured by hardware such as a CPU (central processing unit) or a GPU (graphics processing unit). As shown in FIG. 2, the computation unit 46 includes a movement control unit 54. The movement control unit 54 is realized by the computation unit 46 reading and executing the control program 50 in the storage unit 42.

The movement control unit 54 generates a control command for driving the servo motor 18, and outputs the generated control command to the amplifier 48. When the operation unit 44 is operated, the movement control unit 54 generates different control commands according to the content of the operation. That is, when the first push button 44A is pushed, the movement control unit 54 generates a control command for moving the working device 14 to the retreated position P2. When the second push button 44B is pushed, the movement control unit 54 generates a control command for moving the working device 14 to the working position P1.

The amplifier 48 serves to perform drive control of the servo motor 18, and a control command from the movement control unit 54 is input to the amplifier 48. The amplifier 48 drives the servo motor 18 based on the input control command. The above is the configuration example of the injection molding system 10 according to the present embodiment.

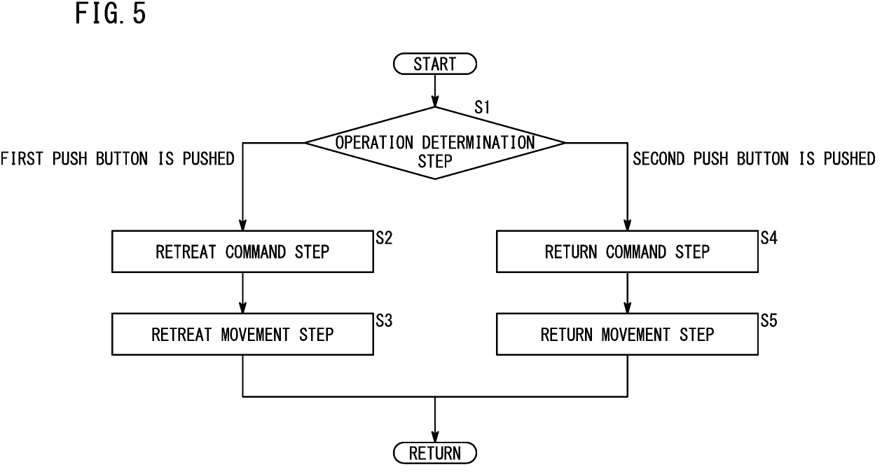

FIG. 5 is a flowchart illustrating a flow of a control method of the injection molding system 10 according to the embodiment.

Next, a control method of the injection molding system 10 (hereinafter, simply referred to as “control method”) will be described. As a premise, it is assumed that both operation of the injection molding machine 12 and operation of the working device 14 are stopped.

The control method includes an operation determination step S1, a retreat command step S2, a retreat movement step S3, a return command step S4, and a return movement step S5.

The operation determination step S1 is a step of determining which one of the first push button 44A and the second push button 44B has been pushed at the time of operating of the operation unit 44. This step is executed by, for example, the movement control unit 54 of the computation unit 46. At this time, the movement control unit 54 may determine whether the signal input from the operation unit 44 to the computation unit 46 is a signal input when the first push button 44A has been pushed or a signal input when the second push button 44B has been pushed.

When it is determined in the operation determination step S1 that the first push button 44A has been pushed, the retreat command step S2 and the retreat movement step S3 are executed.

The retreat command step S2 is a step of generating and outputting a control command for moving the working device 14 to the retreated position P2. This step is executed by the movement control unit 54. The generated control command is input to the amplifier 48.

The retreat movement step S3 is a step of moving the working device 14 to the retreated position P2. This step is executed by the amplifier 48 driving the servo motor 18 based on the control command. Thus, the working device 14 moves to the retreated position P2 illustrated in FIG. 4.

On the other hand, when it is determined in the operation determination step S1 that the second push button 44B has been pushed, the return command step S4 and the return movement step S5 are executed.

The return command step S4 is a step of generating and outputting a control command for moving the working device 14 to the working position P1. This step is executed by the movement control unit 54. The generated control command is input to the amplifier 48.

The return movement step S5 is a step of moving the working device 14 to the working position P1. This step is executed by the amplifier 48 driving the servo motor 18 based on the control command. Accordingly, the working device 14 moves to the working position P1 illustrated in FIG. 3. The above is the configuration example of the control method of the injection molding system 10 according to the present embodiment.

When the operator performs tasks around the mold 24, if the working device 14 is located at the working position P1, there is a possibility that the workability of the operator is adversely affected. For example, consider a case where the working device 14 is located at the working position P1 when the operator performs replacement work of the mold 24 or maintenance work of the mold 24. In this case, the operator cannot use the working space 34 around the mold 24 as the operator wishes when performing his/her work, and has to perform the work while avoiding the working device 14.

In this regard, in the injection molding system 10 of the present embodiment, the working device 14 is moved to the retreated position P2 avoiding the working space 34 around the mold 24 merely by pushing the first push button 44A. Thus, the operator can use the working space 34 at will when performing his/her work. That is, according to the injection molding system 10 of the present embodiment, workability of an operator is improved.

Further, in the injection molding system 10 of the present embodiment, the working device 14 moves to the working position P1, which is positioned under the mold 24, merely by pushing the second push button 44B. Thus, the operator can easily move the working device 14 to the working position P1 after finishing the task or work on the mold 24,

As described above, according to the present embodiment, there is provided the injection molding system 10 which is advantageous for installation in a place where space is limited, and improves workability of an operator with respect to the mold 24.

Moreover, the injection molding system 10 of the present embodiment includes the servo motor 18 as an actuator that generates a driving force (rotational force) for moving the working device 14. The servo motor 18 is a motor having good accuracy of rotation control of the rotary shaft 18a. Therefore, according to the present embodiment, the position control of the working device 14 is realized with good accuracy.

### Modifications

The embodiment has been described above as one example of the present invention. It is noted that various modifications or improvements are capable of being added to the above-described embodiment. Further, it is clear from the scope of the claims that other modes to which such modifications or improvements have been added can be included within the technical scope of the present invention.

Hereinafter, some modified examples according to the embodiment will be specifically described. However, in the following, a description overlapping with the embodiment may be appropriately omitted.

### Modification 1

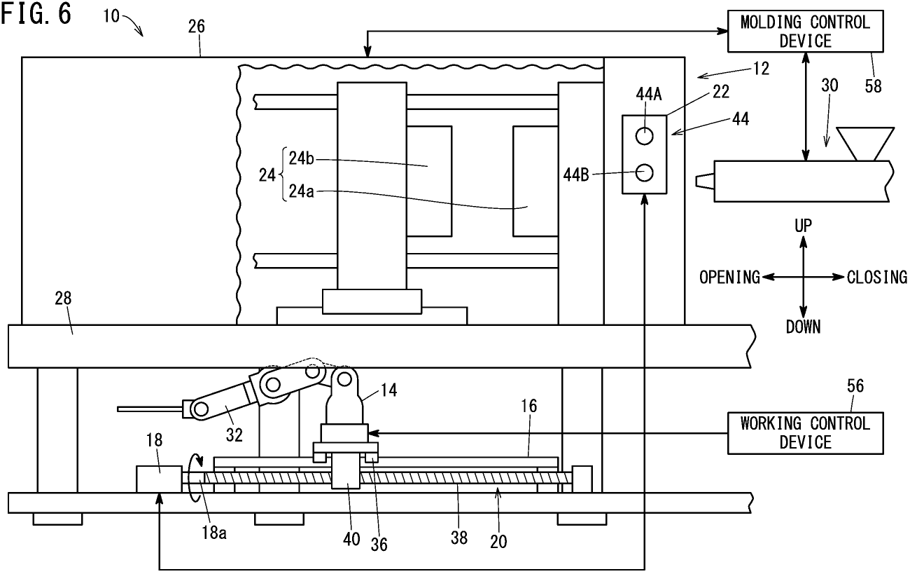

FIG. 6 is a configuration diagram of an injection molding system 10 according to a first modification.

Although not described in the embodiment, the control device 22 may further control the working device 14 and the injection molding machine 12. As shown in FIG. 6, the injection molding system 10 may further include a working control device 56 that controls the working device 14, and a molding control device 58 that controls the injection molding machine 12, as separate devices from the control device 22.

### Modification 2

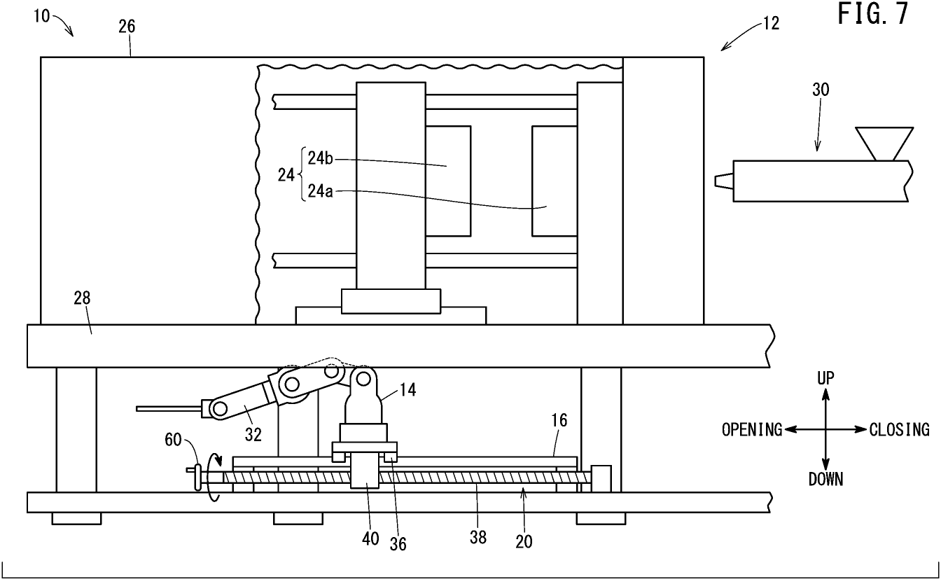

FIG. 7 is a configuration diagram of an injection molding system 10 according to a second modification.

In the embodiment, the servo motor 18 is connected to the ball screw mechanism 20, and the servo motor 18 is controlled by the control device 22 to move the working device 14. The configuration of the injection molding system 10 is not limited thereto. For example, as shown in FIG. 7, a handle 60 may be provided on the ball screw 38 instead of the servo motor 18.

The operator can move the working device 14 by operating the handle 60. That is, in the configuration of FIG. 7, the operator turns the handle 60 to rotate the ball screw 38. The nut 40 is linearly moved by the rotation of the ball screw 38 in the same manner as in the embodiment. Therefore, in the present modification, the working device 14 moves in conjunction with the operator turning the handle 60.

According to this modification, the servo motor 18 and the control device 22 can be omitted from the configuration of the injection molding system 10. Further, the operator can easily move the working device 14 by turning the handle 60.

### Modification 3

In the embodiment, the operation unit 44 having the first push button 44A and the second push button 44B has been described. The number of push buttons included in the operation unit 44 is not limited to this, and may be one. In this case, the movement control unit 54 may generate a control command to move the working device 14 to the retreated position P2 when the push button of the operation unit 44 is pushed once, and generate a control command to move the working device 14 to the working position P1 when the push button is pressed again thereafter.

### Modification 4

The operation unit 44 may include a changeover switch or a changeover lever instead of the first push button 44A and the second push button 44B. In this case, the movement control unit 54 may generate a control command for moving the working device 14 to the retreated position P2 and a control command for moving the working device 14 to the working position P1 in accordance with a switching operation performed on a switch or a lever.

### Modification 5

When the working device 14 performs work or a task, the control device 22 may control the servo motor 18 such that the working device 14 moves to the working position P1. When the working device 14 does not perform work or a task, the control device 22 may control the servo motor 18 such that the working device 14 moves to the retreated position P2.

Such control of the servo motor 18 can be realized by causing the control device 22 to monitor operation of the working device 14 with reference to, for example, the first modification. Accordingly, since the control device 22 also controls the movement of the working device 14, it is possible to save even labor of the operator operating the operation unit 44.

### Modification 6

The tasks performed by the working device 14 are not limited to the task of taking out the molded product. The working device 14 may be a device that performs an insertion task of inserting an insert into the mold 24, or may be a device that performs both the taking-out task and the insertion task. The working position P1 of the mold 24 when the working device 14 performs the insertion task may be a position different from the working position P1 of the mold 24 when the working device 14 performs the taking-out task.

### Modification 7

In relation to the sixth modification, when the working device 14 performs both the taking-out task and the insertion task, the control device 22 may change the working position P1 in accordance with the task content of the working device 14. By changing the working position P1 in accordance with the task content of the working device 14, it is possible to cause the working device 14 to efficiently perform tasks.

Such control of the servo motor 18 can be realized by causing the control device 22 to monitor operation of the working device 14 with reference to, for example, the first modification.

### Modification 8

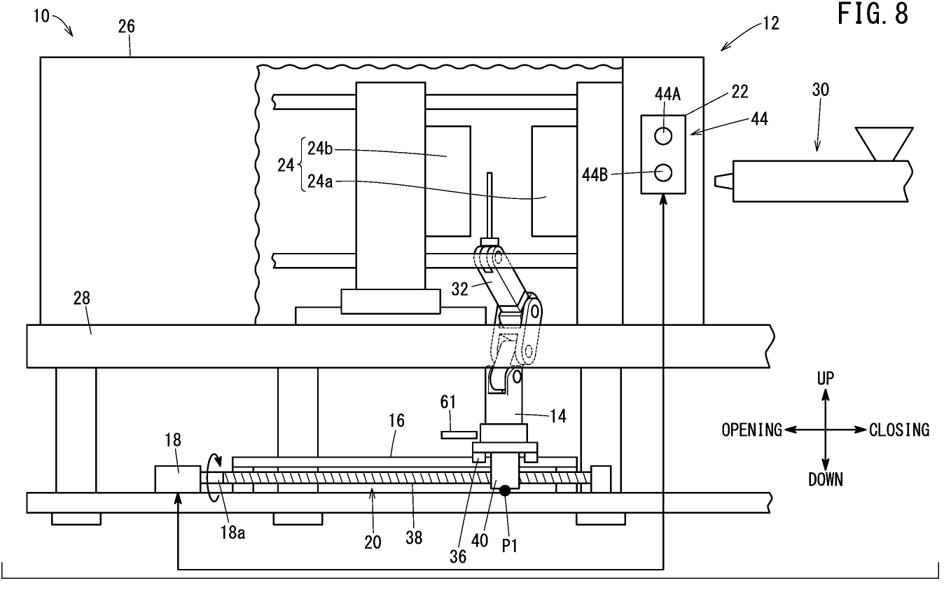

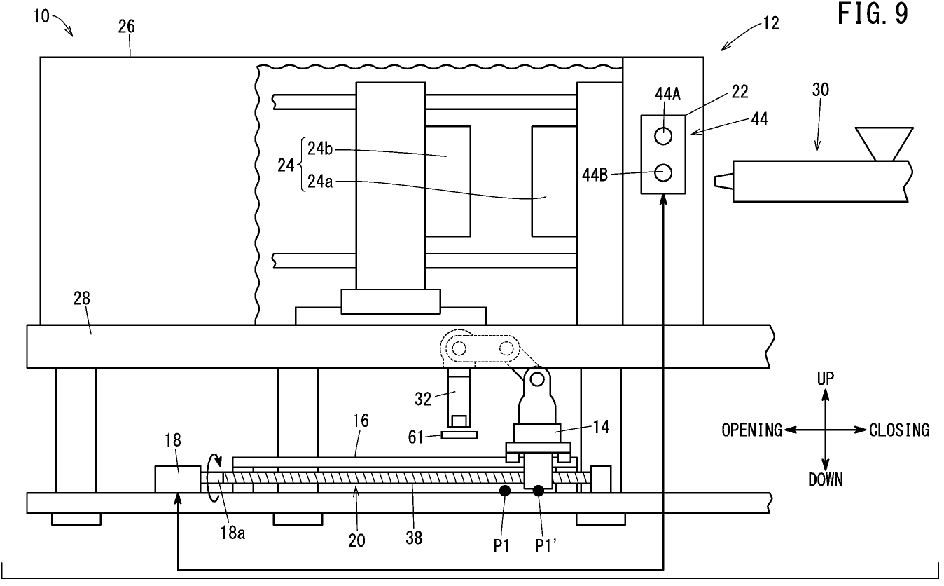

FIG. 8 is a view for explaining the first position (lower position) P1 used in a case where the working device 14 performs the task of taking out the molded product from the mold 24. FIG. 9 is a view for explaining a second position P1′ used in a case where the working device 14 performs a task of placing the molded product taken out from the mold 24 at a predetermined position.

The storage unit 42 of the control device 22 may store the first position (lower position) P1 used in the case where the working device 14 performs the task of taking out the molded product from the mold 24 and the second position P1′ used in the case where the working device 14 performs the task of placing the taken-out molded product at a predetermined position. The movement control unit 54 of the control device 22 may change the position of the working device 14 in accordance with the task performed by the working device 14 based on the positions stored in the storage unit 42. Note that the second position P1′ may not be a position under the mold 24. The predetermined position on which the molded product is placed is, for example, a position on a conveyor 61 for carrying out the molded product.

That is, after the molded product has been taken out, it is necessary to place the molded product at a predetermined position. At this time, the position of the working device 14 at which the molded product is easily taken out and the position of the working device 14 at which the molded product is easily placed at a predetermined position may be different from each other. By changing the position of the working device 14 in accordance with the task performed by the working device 14, it is possible to cause the working device 14 to efficiently perform tasks.

Such control of the servo motor 18 can be realized, for example, by causing the control device 22 to monitor what kind of control is performed on the working device 14 by the working control device 56 (see Modification 1).

### Modification 9

Modification 8 can also be applied to a case where the working device 14 performs the task of inserting an insert. That is, in order to insert the insert into the mold 24, it is necessary for the working device 14 to grip the insert placed at a predetermined position in advance. At this time, the position of the working device 14 where it is easy to grip the insert placed at the predetermined position and the position of the working device 14 where it is easy to insert the gripped insert into the mold 24 may be different from each other. In such a case, the above-described first position (working position P1) may be considered as a position used in a case where the task of inserting the insert into the mold 24 is performed, and the second position P1′ may be considered as a position used in a case where the task of gripping the insert placed at a predetermined position is performed. Accordingly, it is possible to cause the working device 14 to efficiently perform tasks.

The predetermined position at which the insert is placed is, for example, a position on the conveyor 61 similar to that shown in FIGS. 8 and 9. In the case of this modification, the conveyor 61 is a conveyor for carrying-in an insert.

### Modification 10

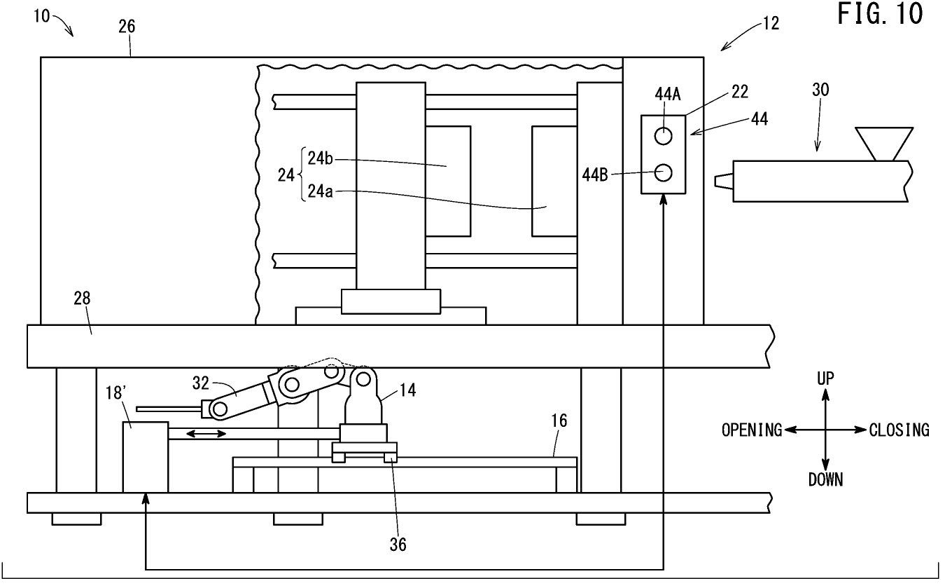

FIG. 10 is a configuration diagram of an injection molding system 10 according to a tenth modification.

The actuator that generates the driving force for moving the working device 14 is not limited to the servo motor 18. For example, a power cylinder such as an air cylinder or a hydraulic cylinder, or a linear motor may be used. In this case, the control device 22 may be configured to control the power cylinder or the linear motor.

Unlike the servo motor 18, the power cylinder or the linear motor is a linear actuator 18′ that generates linear motion power instead of rotational motion power. When the injection molding system 10 includes the linear actuator 18′, the ball screw mechanism 20, which converts the rotational force into a force acting in a direction parallel to the guide rail 16, is not particularly necessary.

### Modification 11

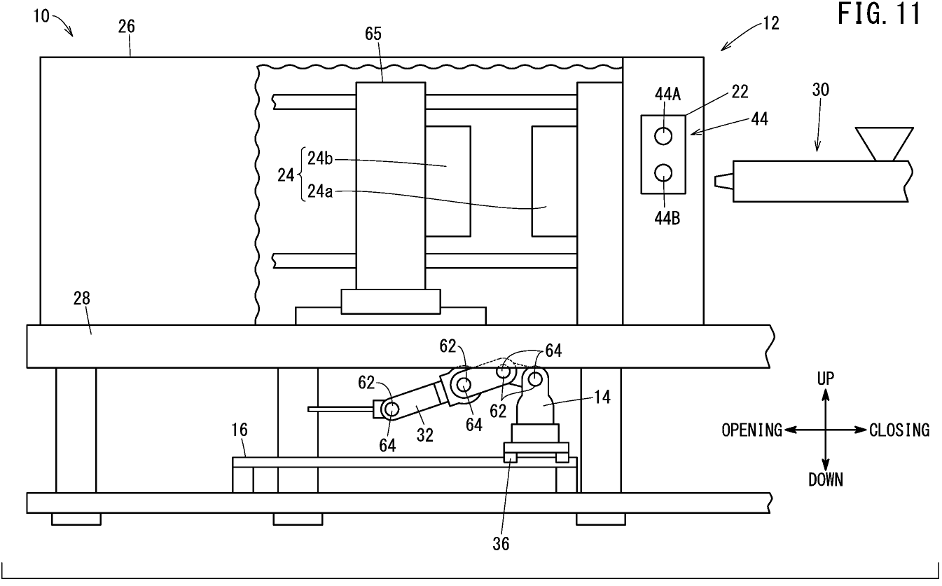

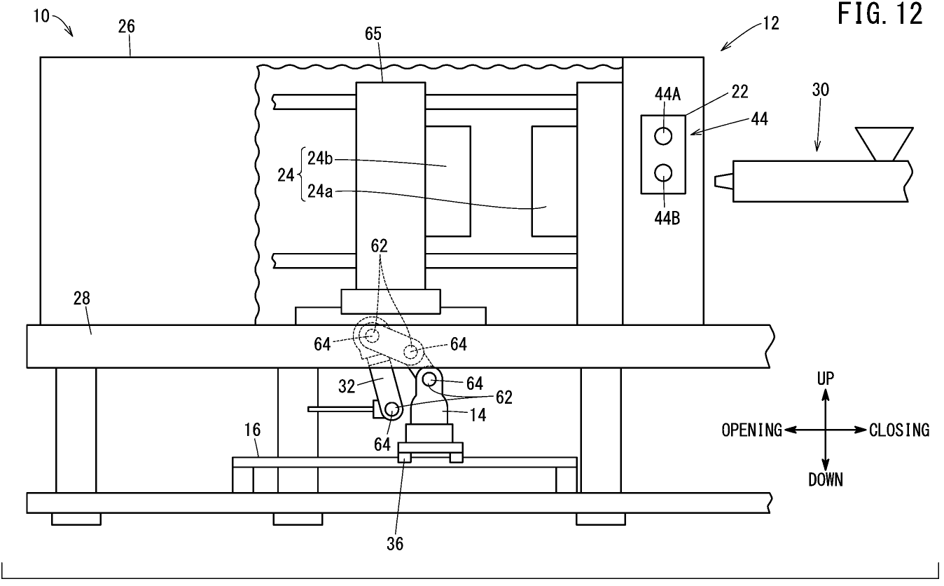

FIG. 11 is a first view for explaining an injection molding system 10 according to an eleventh modification. FIG. 12 is a second view for explaining the injection molding system 10 of Modification 11.

Although not described in the embodiment, in a case where the drive mechanism of the working device 14 is the articulated arm 32 having a plurality of joints 62, as shown in FIGS. 11 and 12, each of the plurality of joints 62 is provided with a joint drive motor 64 for driving the joint 62. The joint drive motor 64 may be used as an actuator that generates a driving force for moving the working device 14.

That is, by controlling the plurality of joint drive motors 64 included in the articulated arm 32, it is possible to cause the articulated arm 32 to grip the machine base 28 or the mold clamping device 26 (FIG. 11) and to bend and stretch the articulated arm 32 (FIG. 12). This makes it possible to move the working device 14. In addition, according to this configuration, the ball screw mechanism 20 described in the embodiment becomes unnecessary.

Such movement of the working device 14 can be realized by the control device 22 controlling the articulated arm 32 or by requesting the working control device 56 to control the articulated arm 32, for example, with reference to Modification 1.

By causing the articulated arm 32 to grip a movable portion of the mold clamping device 26, it is also possible to move the working device 14 along with the movement of the movable portion. The movable portion of the mold clamping device 26 is, for example, a movable platen 65. The movable platen 65 is a member that moves in the opening/closing direction along with the movable mold 24b in order to realize opening and closing of the mold 24. That is, by causing the articulated arm 32 to grip the movable platen 65 from below, it is possible to move the working device 14 in the opening/closing direction in accordance with the movement of the movable platen 65.

### Modification 12

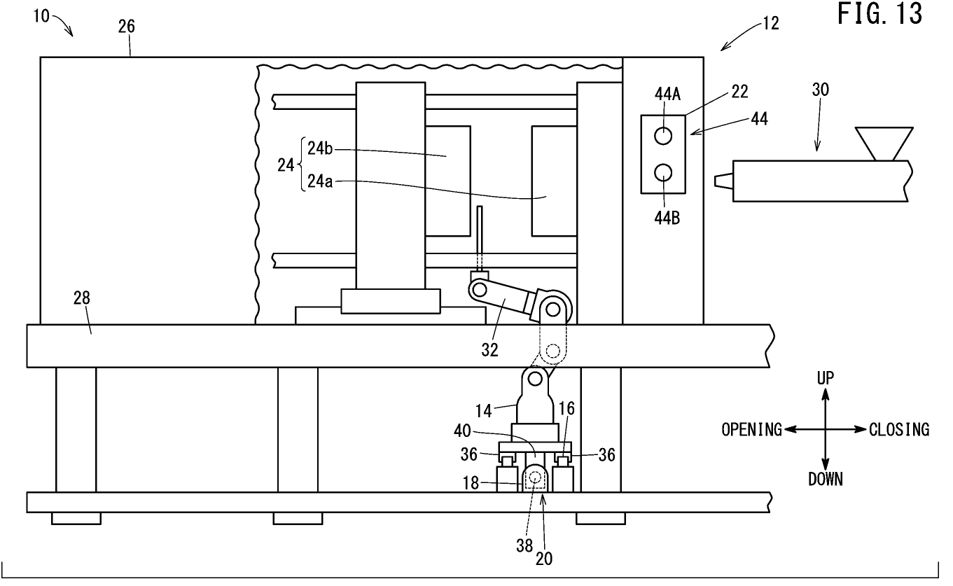

FIG. 13 is a configuration diagram of an injection molding system 10 according to a twelfth modification. FIG. 14 is a first view of the injection molding system 10 of FIG. 13 viewed from the opening direction side of the injection molding machine 12.

In the embodiment, the injection molding system 10 has been described in which the guide rail 16 extending in parallel to the opening/closing direction is provided to enable the movement of the working device 14 in parallel to the opening/closing direction. The configuration of the injection molding system 10 is not limited thereto. For example, as shown in FIGS. 13 and 14, the injection molding system 10 may include a guide rail 16 that extends parallel to the width direction (the left-right direction in FIG. 14) of the machine base 28 orthogonal to the opening/closing direction and the up-down direction. Thus, the working device 14 can be moved parallel to the width direction.

FIG. 14 illustrates a state in which the working device 14 is at the working position P1 of the mold 24. In this state, similarly to the embodiment, the working device 14 performs tasks on the injection molding machine 12 at the working position P1.

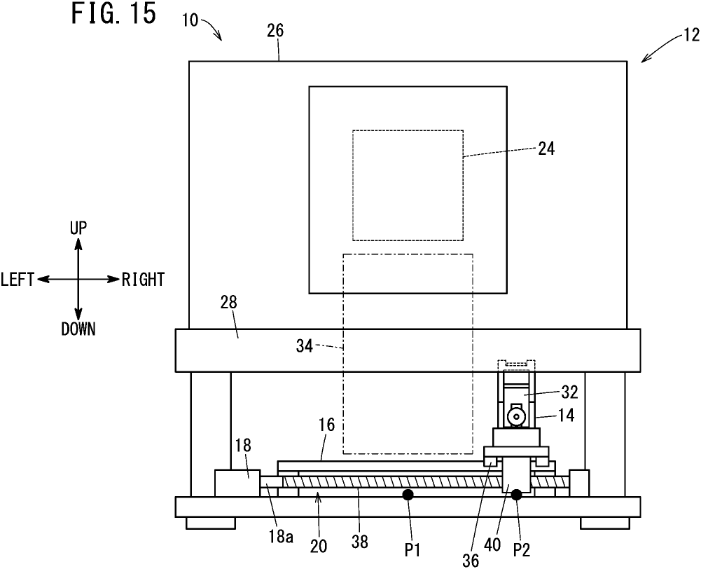

FIG. 15 is a second view of the injection molding system 10 of FIG. 13 as viewed from the opening direction side of the injection molding machine 12.

FIG. 15 illustrates a state in which the working device 14 is at the retreated position P2. As shown in FIG. 15, the retreated position P2 and the working position P1 are arranged side by side with each other in the width direction of the machine base 28 in the present modification. Also in the present modification, by moving the working device 14 to the retreated position P2, the working space 34 for the operator can be secured around the mold 24 including the working position P1.

### Modification 13

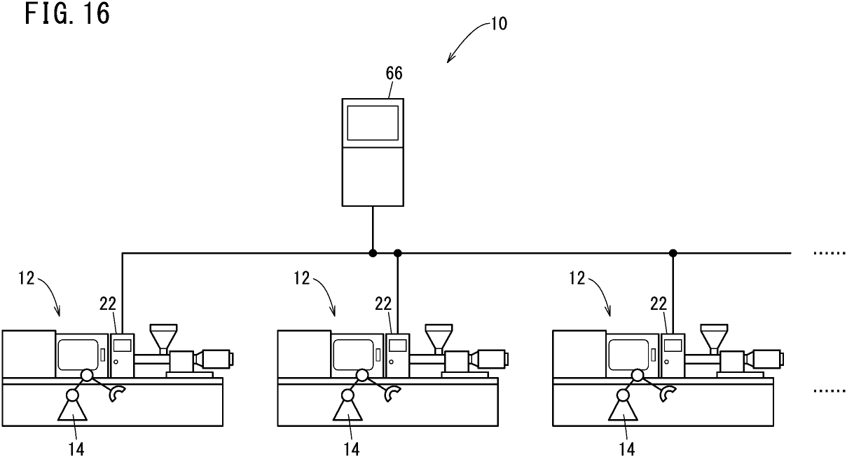

FIG. 16 is a configuration diagram of an injection molding system 10 according to a thirteenth modification.

As shown in FIG. 16, the injection molding system 10 may include a plurality of the configurations illustrated in FIG. 1. In this case, the injection molding system 10 may further include a centralized control apparatus 66 to which the plurality of control devices 22 are connected and which collectively sets (or specifies) at least one of the working position P1 or the retreated position P2 on the plurality of control devices 22 at a time.

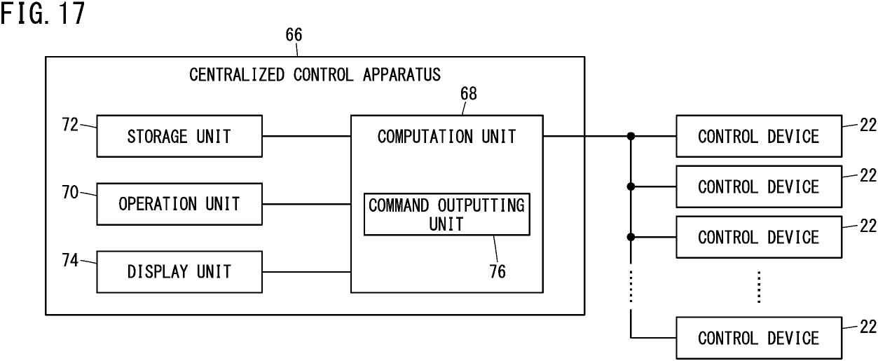

FIG. 17 is a schematic configuration diagram of the centralized control apparatus 66.

The centralized control apparatus 66 is an electronic device (computer) connected to the plurality of control devices 22 via a network. The centralized control apparatus 66 includes a computation unit 68, an operation unit 70, a storage unit 72, and a display unit 74.

The computation unit 68 is configured by a CPU or a GPU similarly to the computation unit 46 of the control device 22, and serves for overall control of the centralized control apparatus 66.

The storage unit 72 is configured by a ROM or a RAM similarly to the storage unit 42 of the control device 22, and appropriately stores programs necessary for control performed by the computation unit 68, information input by an operator using the operation unit 70, and the like.

The display unit 74 displays information and includes, for example, a liquid crystal screen. Information or the like input by the operator through the operation unit 44 is appropriately displayed on the display unit 74.

The operation unit 70 is an interface operated by an operator to set (or specify) at least one of the working position P1 or the retreated position P2. The operation unit 70 includes, for example, a mouse, a keyboard, or a touch panel provided on the screen of the display unit 74.

The computation unit 68 includes a command outputting unit 76. The command outputting unit 76 outputs at least one of the working position P1 or the retreated position P2 set by the operator to the plurality of control devices 22 connected to the centralized control apparatus 66. When moving the working device 14, each of the plurality of control devices 22 controls the motor (18, 18′, 64), which is the control target of the control device 22, based on the information input from the centralized control apparatus 66. The motor in this case is preferably a servo motor from the viewpoint of control accuracy.

According to the present modification, it is possible to collectively set at least one of the working position P1 or the retreated position P2 on the plurality of control devices 22 at a time. Accordingly, it is possible to reduce the time and effort of the work of setting the working position P1 and the retreated position P2 on the plurality of control devices 22. In addition, it is possible to reduce a possibility that an operation error such as omission of setting of information with respect to any of the plurality of control devices 22 may occur.

### Modification 14

In relation to Modification 13, one of the plurality of control devices 22 may be used as the centralized control apparatus 66. That is, the injection molding system 10 may be configured such that, when at least one of the working position P1 or the retreated position P2 is set on one of the plurality of control devices 22, the setting is also applied to the other control devices 22.

### Modification 15

The modifications may be appropriately combined within a range in which no technical inconsistencies occur.

### Inventions That Can Be Obtained From the Embodiment

The inventions that can be grasped from the above-described embodiment and the modifications thereof will be described below.

The injection molding system (10) includes: the injection molding machine (12) including the mold clamping device (26) configured to open and close the mold (24) and the machine base (28) configured to support the mold clamping device (26) from below; the working device (14) that is provided under the mold clamping device (26) and is configured to perform at least one of a task of taking out a molded product from the mold (24) or a task of inserting the insert into the mold (24); and the guide rail (16) configured to retreat the working device (14) from under the mold (24), in a location under the mold clamping device (26).

With this configuration, it is possible to provide the injection molding system (10) which is advantageous for installation in a place where space is limited, and improves workability of an operator with respect to the mold (24).

The guide rail (16) may be disposed to allow the working device (14) to move in parallel to the opening/closing direction of the mold (24). This reduces the possibility that the working device (14) may protrude outside the machine base (28) in the width direction of the machine base (28) even if the working device (14) is moved to the retreated position (P2).

The injection molding system (10) may further include: the ball screw (38) installed parallel to the guide rail (16); the nut (40) provided in the working device (14) and configured to be screw-engaged with the ball screw (38); and the handle (60) provided on the ball screw (38) and configured to be operated by an operator to thereby rotate the ball screw (38). Thus, the operator can move the working device (14) by operating the handle (60).

The injection molding system (10) may further include the actuator (18, 18′, 64) that generates a driving force for moving the working device (14) along the guide rail (16), and the control device (22) that controls at least the actuator (18, 18′, 64). This makes it possible to move the working device (14) without being manually pushed by the operator.

The working device (14) may include the articulated arm (32), the actuator (64) may be provided to drive the articulated arm (32), and the control device (22) may control the actuator (64) to cause the articulated arm (32) to grip the machine base (28) or the mold clamping device (26), and cause the articulated arm (32) to bend and stretch to move the working device (14). This makes it possible to move the working device (14).

The control device (22) may control the actuator (18, 18′, 64) in a manner that the working device (14) moves to the lower position (P1) that is under the mold (24) or the retreated position (P2) that is away from the mold (24), in accordance with an operation performed by an operator. Thus, the operator can easily move the working device (14) to the retreated position (P2) avoiding the position that is under the mold (24), merely by operating the control device (22).

The control device (22) may control the actuator (18, 18′, 64) in a manner that the working device (14) is moved to the lower position (P1) that is under the mold (24), when the working device (14) performs tasks, and the working device (14) is moved to the retreated position (P2) that is away from the mold (24), when the working device (14) does not perform tasks. This makes it possible to eliminate even the time and effort required for the operator to operate the operation unit (44).

The actuator (18, 18′, 64) may be a motor, and the control device (22) may change the lower position (P1) in accordance with the task content of the working device (14). This makes it possible to cause the working device (14) to perform tasks efficiently.

The actuator (18, 18′, 64) may be a motor. Further, the control device (22) may include the storage unit (42) configured to store the lower position (P1) and the retreated position (P2) according to the type of the molded product molded by using the mold (24), and the control device (22) may control the motor in a manner that the working device (14) moves to the lower position (P1) or the retreated position (P2) according to the mold (24) attached to the injection molding machine (12). Thus, the movement of the working device (14) can be controlled based on the lower position (P1) and the retreated position (P2) stored in the storage unit (42) .

The storage unit (42) may further store the first lower position (P1) used in a case where the task of taking out the molded product is performed or the task of inserting the insert is performed, and the second position (P1′) used in a case where a task of placing the molded product taken out by the working device (14) at a predetermined position (61) is performed or a task of gripping the insert placed at the predetermined position is performed, and the control device (22) may change the position of the working device (14) by using the storage unit (42). This makes it possible to cause the working device (14) to perform tasks efficiently.

The injection molding system (10) may further include a centralized control apparatus (66) to which a plurality of the control devices (22) are connected and that is configured to collectively set at least one of the lower position (P1) or the retreated position (P2) on the plurality of control devices (22) at a time. With this configuration, it is possible to reduce the time and effort of the task of setting the lower position (P1) and the retreated position (P2) on the plurality of control devices (22). In addition, it is possible to reduce a possibility that an operational error such as omission of setting of information with respect to any of the plurality of control devices (22) may occur.

1. An injection molding system comprising:
an injection molding machine including a mold clamping device configured to open and close a mold and a machine base configured to support the mold clamping device from below;
a working device that is provided under the mold clamping device and is configured to perform at least one of a task of taking out a molded product from the mold or a task of inserting an insert into the mold; and
a guide rail configured to retreat the working device from under the mold, in a location under the mold clamping device.

2. The injection molding system according to claim 1, wherein the guide rail is disposed to allow the working device to move in parallel to an opening/closing direction of the mold.

3. The injection molding system according to claim 1 , further comprising:
a ball screw disposed parallel to the guide rail;
a nut provided in the working device and configured to be screw-engaged with the ball screw; and
a handle provided on the ball screw, wherein an operator operates the handle to thereby rotate the ball screw.

4. The injection molding system according to claim 1 , further comprising:
an actuator configured to generate a driving force for moving the working device along the guide rail; and
a control device configured to control at least the actuator.

5. The injection molding system according to claim 4, wherein:
the working device includes an articulated arm;
the actuator is provided to drive the articulated arm; and
the control device controls the actuator to cause the articulated arm to grip the machine base or the mold clamping device, and cause the articulated arm to bend and stretch to move the working device.

6. The injection molding system according to claim 4 , wherein the control device controls the actuator in a manner that the working device moves to a lower position that is under the mold or a retreated position that is away from the mold, in accordance with an operation performed by an operator.

7. The injection molding system according to claim 4 , wherein the control device controls the actuator in a manner that the working device is moved to a lower position that is under the mold, when the working device performs tasks, and the working device is moved to a retreated position that is away from the mold, when the working device does not perform tasks.

8. The injection molding system according to claim 7, wherein:
the actuator is a motor; and
the control device changes the lower position, in accordance with task content of the working device.

9. The injection molding system according to claim 6 , wherein:
the actuator is a motor; and
the control device includes a storage unit configured to store the lower position and the retreated position according to a type of the molded product molded by using the mold, and the control device controls the motor in a manner that the working device moves to the lower position or the retreated position in accordance with the mold attached to the injection molding machine.

10. The injection molding system according to claim 9, wherein:
the storage unit further stores a first lower position used in a case where the task of taking out the molded product is performed or the task of inserting the insert is performed, and a second position used in a case where a task of placing the molded product taken out by the working device at a predetermined position is performed or a task of gripping the insert placed at the predetermined position is performed; and
the control device changes a position of the working device by using the storage unit.

11. The injection molding system according to claim 8, further comprising:
a centralized control apparatus to which a plurality of the control devices are connected and that is configured to collectively set at least one of the lower position or the retreated position on the plurality of control devices at a time.
